(19) United States
(12) Patent Application Publication
(10) Pub. No.: US 2010/0212560 A1
(43) Pub. Date: Aug. 26, 2010

(54) GEOMAT

(76) Inventors: Jan Holland-Moritz, Oberschoenau (DE); Raik Holland-Moritz, Oberschoenau (DE)

Correspondence Address: MICHAEL J. STRIKER, 103 EAST NECK ROAD, HUNTINGTON, NY, 11743, US

(21) Appl. No.: 12/677,040

(22) PCT Filed: Aug. 27, 2008
(86) PCT No.: PCT/DE08/01428

§ 371 Date: Apr. 15, 2010

(30) Foreign Application Priority Data
Sep. 10, 2007 (DE) 20 2007 012 632.8

(51) Int. Cl. A01G 13/02; D03D 15/00; E02D 17/20

(52) U.S. Cl. 111/200; 442/203; 442/189; 405/302.6

(57) ABSTRACT

The invention relates to a geomat for preventing erosion, for recultivating fallow land and for cultivating plants, said mat being completely biodegradable, cost-effective and simple to produce and fulfilling all ecological requirements. According to the invention, the geomat substantially consists of a continuous strand (1) of untreated sheep's wool, arranged in a serpentine to form the desired width of the mat and held together in a longitudinal direction.

The present invention describes a geomat which is used as erosion control and as an aid to grow greenery, and to cultivate and grow plants.

Textile sheet materials are known, as geotextiles in the form of single-layered or multiple-layered mats which are composed of cloth and/or formed fabric, and which are used to prevent erosion, to support vegetation, and as an aid to grow greenery; they typically include a portion of plant fibers and additional additives, and are at least partially decomposable.

DE 202 07 782 U1 makes known a landscaping aid that also prevents erosion, and functions as a soil substrate, stores water and nutrients, provides nutrients via biodegradable components and additives, and is composed primarily of renewable raw materials; it is used to prevent water and wind erosion, and to grow greenery in extreme locations.

This landscaping aid is composed of a textile sheet material made of synthetic resin or plant fibers, and a mixture of organic substances, such as rape, molasses, plant fibers, sawdust, cellulose, compost, feather meal, and horn dust, to which water-absorbing and mineral substances and binders may be added. The mixture mass is applied in a grid shape at the intersection points of the textile sheet material.

Grasses and the like are certain to grow, since the stability is given for only one vegetation period, and since the nutrient depot suffices for only one vegetation period, but this is insufficient for wood. When synthetic resin fibers are used for the textile sheet material, they do not fully decompose.

In addition, the landscaping aid is complex to manufacture.

Publication DE 299 18 940 U1 describes a textile mat for growing greenery on ground surfaces that lack topsoil. The textile mat, which is designed as a multiple-layered element, is primarily composed of decomposing fibrous materials having a wavy surface.

The multiple-layered element includes a textile netting as the solid-supporting underlayer, a middle layer composed of a fibrous formed fabric that is composed primarily of decomposable fibers interspersed with functional elements such as plant seeds, water storage elements and fertilizer, and a cover layer composed of a thin formed fabric made of grass-green fibers. Water-storing and water-impounding lines of action are created by connecting the three layers together in a stepped manner at certain distances, parallel to the direction of manufacture.

The multiple-layered design of the mat, and the fact that it is manufactured of highly diverse materials are also highly complex.

A vegetation carrier that is composed of organic, decomposable fibrous materials is described in DE 20 2005 004 354 U1, the vegetation-carrying layer of which is composed of a formed fabric made of untreated sheep's wool, which is fixed in position via a reinforcing sheet on the top side and the bottom side, and/or via a reinforcing fiber in order to create the necessary tensile strength.

According to this solution as well, it is only possible to realize vegetation layers that have a closed surface, that make it difficult to plant plants or seeds, and that are also complex to manufacture.

When used for cultivation in greenhouses, it is also enclosed, on the surface or completely, in a plastic sheet, which is not environmentally friendly.

The object of the present invention is to develop a geomat for preventing erosion, recultivating fallow land, and for cultivating plants, which is completely biodegradable, may be manufactured easily and cost-effectively, and which meets all ecological requirements.

A geomat according to the present invention is substantially composed of one continuous strand of untreated sheep's wool, which is arranged in a serpentine to form the desired width of the mat, and which is held together in a longitudinal direction.

Optionally, straw or hay may be added, as an additional nutrient supplier, to the strand of sheep's wool.

The diameter of the strand is in the range of 2 to 10 cm, preferably 4 cm.

Depending on the intended use of the geomat, e.g., to prevent erosion and as an aid to grow greenery, the distance between the meandering sections is at least one-half the diameter of the strand, up to several diametes of the strand, and, in particular, a single diameter of the strand.

A plurality of connections, in particular in the form of warp-woven chains, is located in the longitudinal direction, one on each side and distributed across the width.

The distance between the connections is selected such that the distance between the strands is retained when the geomat is laid down.

When the geomat is used to cultivate or grow plants, the strands of the serpentine are located directly adjacent to one another as weft, and are connected via twine that is interwoven in the longitudinal direction, thereby resulting in a geomat that has a closed surface.

Plants to be cultivated may be placed in the strands, or, if the geomat will be used to create a growth-promoting microclimate and to prevent evaporation, plants may be placed between the strands that form the meander.

The connections are composed of twine which is also composed of sheep's wool or another decomposable material, such as hemp or coconut fibers.

After manufacture, the geomat is rolled up, thereby resulting in a roll having a preferred width of 120 centimeters and making it possible to utilize common shipping and storage means in an optimal manner.

Seeds of grasses and the like, and starting fertilizer may be integrated in the geomat or strands in the usual manner.

The advantages of geomats that are composed of untreated, natural sheep's wool are, in particular, that:
sheep's wool is capable of absorbing and storing precipitation in the order of magnitude of four times its own mass, and of slowly releasing it to the surroundings, the seeds, plant roots, and the ground below;
it protects the soil against evaporation;
it prevents the erosion of soil components that have been placed between the meandering strands or that are located underneath the geomat;
a drainage effect is attained for diverting large quantities of precipitate to drainage systems via the meander;
plant seeds and additional nutrient depots may be integrated in the strand in the usual manner;
a microclimate with temperature compensation and cold insulation, which promotes plant growth, is created near the surface of the geomat, thereby simply making it possible to cultivate certain cultures in places having unfavorable climates, and making it possible to increase yields;
the material of the geomat, the sheep's wool, provides nutrients that promote plant growth when it decomposes.

No waste is produced when the geomat is produced out of sheep's wool.

A product that meets all ecological requirements is therefore made available in the form of the geomat which decomposes within the time required for the seeds and/or plants integrated in the geomat to grow until the vegetation has progressed to the point where its roots reliably prevent soil erosion.

The geomat may also be used as a plant substrate.

The geomat is advantageously placed on prepared, flattened ground. On hilly terrain, it is fastened, in a manner known per se, using decomposable ground nails, wooden stakes, or cuttings that take root.

It is possible, but typically not necessary, to install an additional geomat containing soil, as a cover, to sow seeds or to plant plants.

In addition, the production of sheep's wool, which is used as the starting material for the geomat, also takes place in complete harmony with the environment and nature.

No special requirements are placed on the sheep's wool since it is used to form the strands in the conventional manner.

Any type of untreated sheep's wool or wool having similar properties may be used to form the strands and, therefore, to manufacture the geomat.

The present invention is described in greater detail as an exemplary embodiment with reference to the following figures, which are:

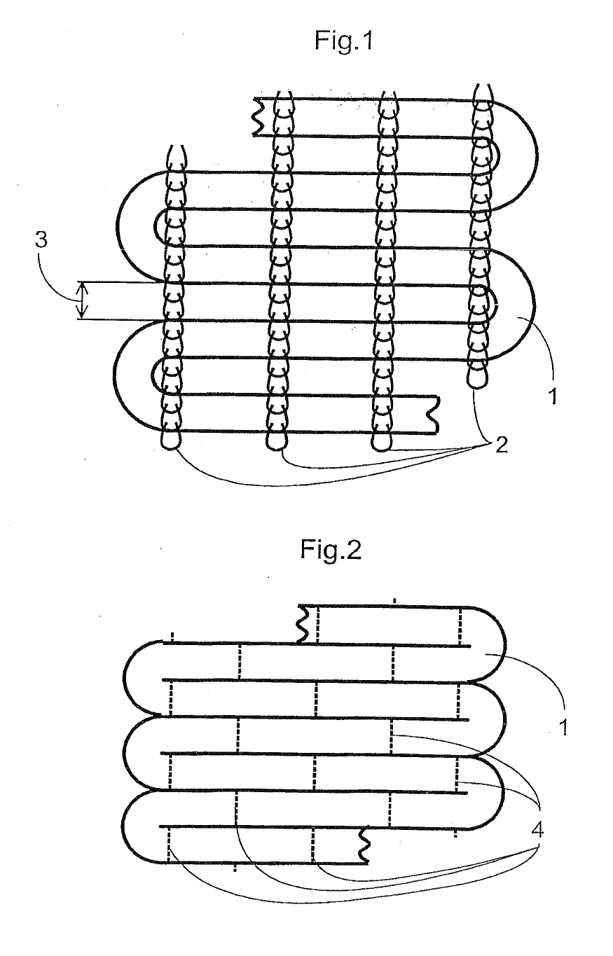

FIG. 1 shows a schematic depiction of a geomat for use as erosion control and an aid to grow greenery, and

FIG. 2 shows a schematic depiction of a geomat for use to cultivate or grow plants.

As shown in FIG. 1, a geomat for erosion control and as an aid to grow greenery is composed of one continuous strand 1 of untreated sheep's wool which is arranged in a meandering manner across the width, and which is connected via warp-woven chains 2 in the longitudinal direction. Warp-woven chains 2 are situated on each side and in plurality across the width of the geomat in such a manner that a distance 3 between the meandering strands is retained when the geomat is placed on the ground.

A geomat which is used to cultivate or grow plants is shown in FIG. 2. In this case, strands 1 of the serpentine are located directly adjacent to one another as weft, and are preferably connected via decomposable twine 4 that is interwoven in the longitudinal direction, thereby resulting in a geomat that has a closed surface.

### REFERENCE NUMERALS USED

1 Geomat
2 Warp-woven chain
3 Distance
4 Twine

What is claimed is:

1. A geomat that is composed of untreated sheep's wool and is used to prevent erosion, recultivate fallow land, and cultivate plants, wherein
the geomat is substantially composed of one continuous strand (1) of untreated sheep's wool, which is arranged in a serpentine to form the desired width of the mat, and which is held together in a longitudinal direction.

2. The geomat as recited in claim 1, wherein
the meandering sections of the strand (1) are separated from one another by at least one-half the diameter of the strand (1), up to several diameters of the strand (1), and preferably by a single diameter of the strand (1), and are connected via warp-woven chains (2) that extend in the longitudinal direction, are located on both sides, and a plurality of which are located across the width.

3. The geomat as recited in claim 1, wherein
the meandering sections of the strand (1) are located directly adjacent to each other, as weft, and are connected via decomposable twine (4) that is interwoven in the longitudinal direction, thereby resulting in a geomat that has a closed surface.

4. The geomat as recited in claim 1, wherein
the strand (1) has a diameter in the range of 2 to 10 cm, and preferably 4 cm.

5. The geomat as recited in claim 1, wherein
straw or hay is added to the sheep's wool in the strand (1).

6. The geomat as recited in claim 1, wherein
plant seeds and additional nutrient depots are integrated in the strand (1).
